(19) United States
(12) Patent Application Publication
(10) Pub. No.: US 2014/0041092 A1
(43) Pub. Date: Feb. 13, 2014

(54) Magnetic Potholder Grips

(71) Applicant: Richard H. Ebbott, Flint, MI (US)

(72) Inventor: Richard H. Ebbott, Flint, MI (US)

(21) Appl. No.: 13/572,228

(22) Filed: Aug. 10, 2012

(51) Int. Cl. A47J 45/10

(52) U.S. Cl. 2/20

(57) ABSTRACT

The invention is a pot holder designed to insulate the user from the heated or cold surface of a platter, plate, pan, bowl or other food container or of any vessel while remaining attached to the platter, etc. by means of magnets. The potholder is comprised of any material of sufficient insulating property to prevent the transmission of heat or cold to the user. The potholder can be of any size and dimensions but must be of sufficient size when folded in half to allow the user to grip the platter, etc. Incorporated within the potholder will be four (4) magnets one at each corner (or opposite areas for non-rectangular shaped potholders) of sufficient strength to independently but temporarily affix the potholder to the platter, etc. The magnets will further be magnetized in such a manner and incorporated into the potholder in such fashion that each magnet will attract the opposing magnet when the potholder is folded in half.

### FIELD OF THE INVENTION

This invention relates generally to portable, temporary kitchen handgrips to move hot or cold objects without discomfort from the heat or cold of the object to the user by incorporating magnets into the handgrips, which are generally referred to as a potholders, with the magnets having sufficient magnetic strength that the potholder will remain in place about the object when the user releases the object.

### BACKGROUND OF THE INVENTION

Potholders of many different fabrics are well known for grasping and moving hot or cold objects such as platters, serving bowls or dishes. They are exemplified by U.S. Pat. No. 6,112,372 issued Sep. 5, 2000 to Zhou, et al., and U.S. Pat. No. 7,669,291 issued Mar. 2, 2010 to Blum which teaches that handgrips with magnets may be formed into a tubular shape and placed about the handle of a skillet or metal pot. However all potholders described to date do not remain adhered to the article itself, particularly those articles not having handles like skillets or metal pots, thereby eliminating the need for reforming and repositioning the potholder with each use.

### SUMMARY OF INVENTION

It is accordingly the object of the invention to provide a potholder that will insulate the user from heat or cold, which through the incorporation of magnets of sufficient strength and placement, the potholder once placed about an article will remain affixed to the article until intentionally removed by the user.

The purpose and function of the invention may become more apparent from a review of the drawings and descriptions of exemplary uses of the invention which accompany the application.

### BRIEF DESCRIPTION OF THE DRAWINGS

FIG. 1 is a top cutaway view of the device.

FIG. 2 is a side cutaway view of the device.

FIG. 3 is a top view showing 2 of the devices in place at the ends of a serving platter.

FIG. 4 shows a side view of a serving platter with 2 of the devices in place on opposite ends of the platter.

FIG. 5 shows a cutaway side view of a pot or kettle with 2 of the devices in place on the top and opposite sides.

FIG. 6 shows a top view of the pot or kettle with 2 of the devices in place.

FIG. 7 shows a side view of the pot or kettle with a device in place.

### DETAILED DESCRIPTION OF PREFERRED EMBODIMENTS

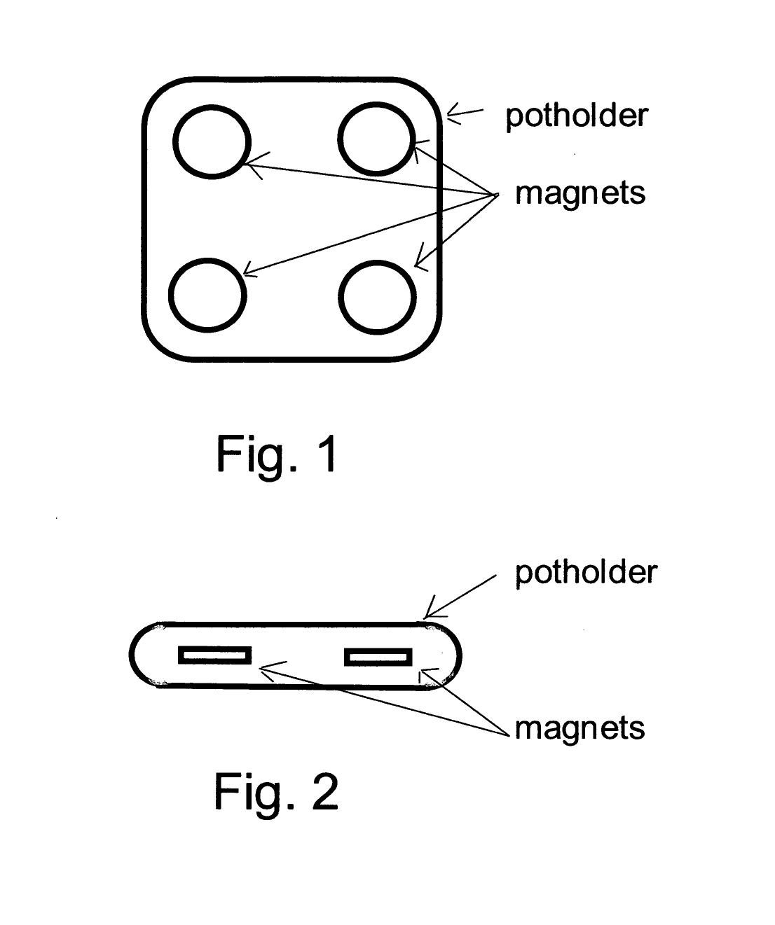

Referring to FIG. 1 and FIG. 2 the potholder is cut and sewn from any fabric or material, and may be constructed of layers of such, so that the potholder has sufficient insulating properties to protect the user from the heat or cold of the object to which the potholder will be applied. It is anticipated that the magnets will be held in place within the potholder by sewing, the use of adhesives or any other suitable means. It is also anticipated, although not necessary for the device, that the magnets will incorporated within layers of the potholder and not exposed. The magnets can be of any shape, any material, coated with a protective substance or not, and magnetized in any orientation as long as the polarities are opposite those polarities on the opposing magnet when the potholder is folded about an object. The magnets could be electric magnets if attached or attachable to a sufficient source of electricity. The magnets must have sufficient magnetic strength to hold the potholder in place when the user's hands are removed.

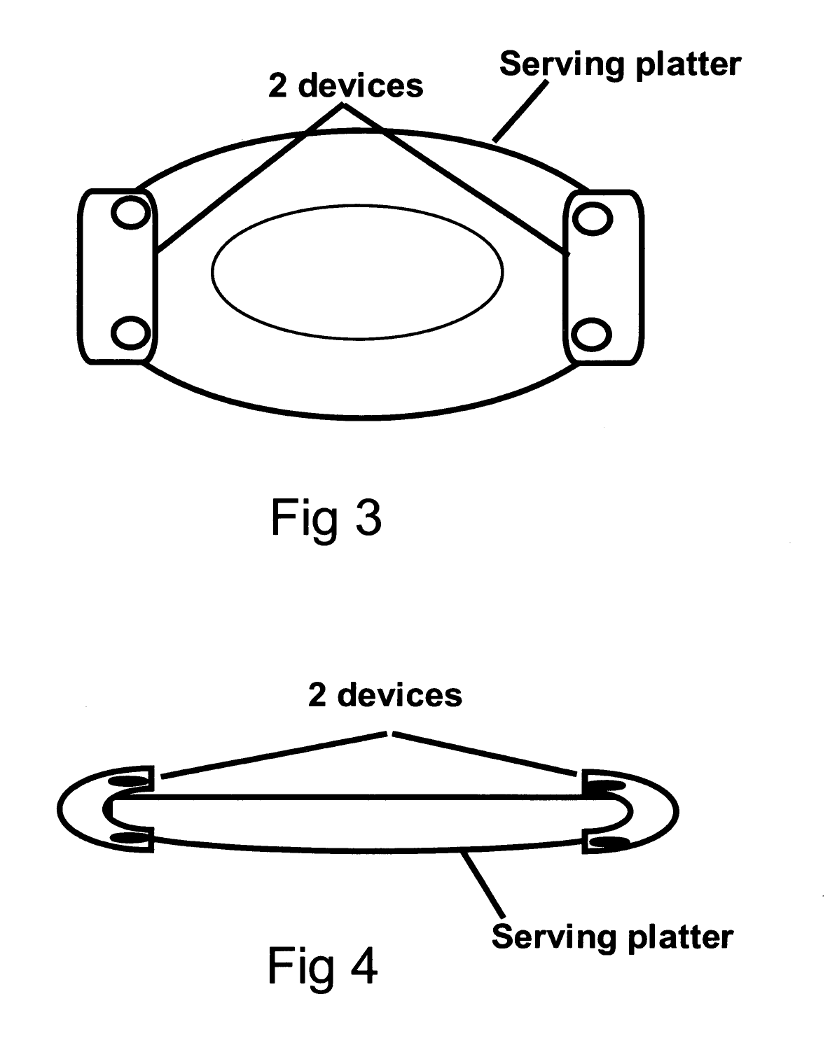

Referring to FIG. 3 and FIG. 4 the usefulness of the device is shown with a serving platter that is too hot (or cold) to be picked up and moved comfortably with bare hands. Often a serving platter or individual plate is heated (or chilled) to keep the food hot (or cold) longer. Ordinary potholders are picked up in each hand and folded about the platter or dish. However when the platter or dish is set down, the potholders fall away. To move the platter or dish again the potholders must be gathered up and repositioned about the platter or dish. This becomes particularly problematical when a platter or dish is passed from person to person.

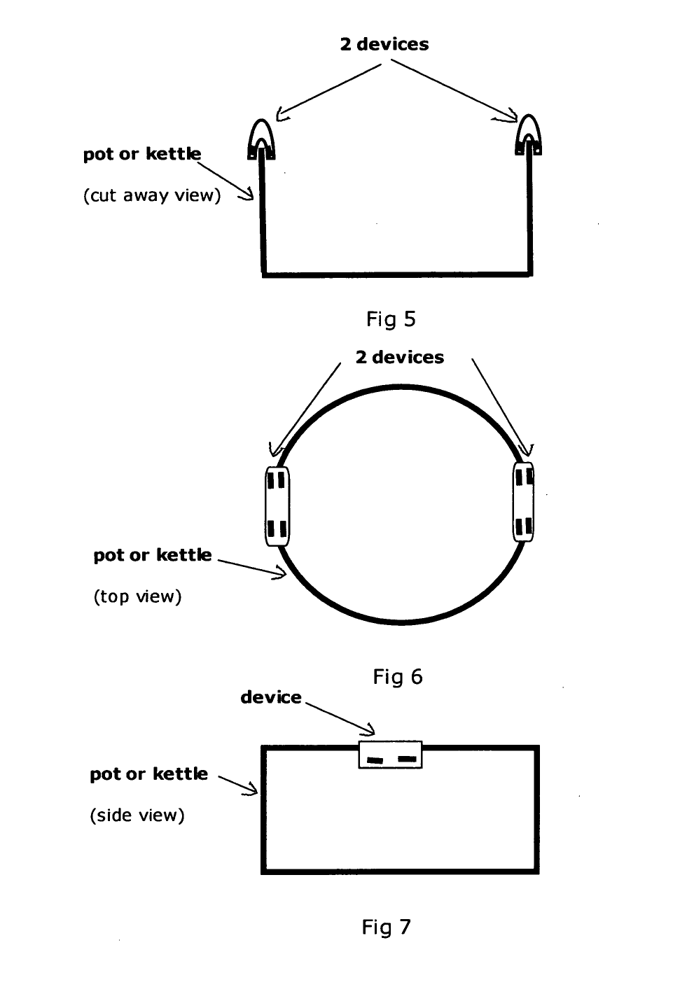

Referring to FIG. 5, FIG. 6. and FIG. 7 we see the use of the device to lift and otherwise maneuver a pot or kettle, or any other container without surfaces of a comfortable temperature for doing so. Here too the common use is to gather a potholder in each hand and fold it about the top edge or other suitable area of the vessel. But once the vessel is set down the potholders have to be removed lest they fall into the soup. With the device in use the potholders will remain in place until their removal is desired.

The devices is FIGS. 1-7 can also be of any size and shape. They could also have their own handles for lifting an object once the device is in place. The uniqueness of the invention is that the magnets are not only incorporated in the potholder but the magnets are incorporated such that they can be placed on opposite surfaces of an object and the magnets have sufficient magnetic strength to hold the potholder in place when the user's hands are removed.

The fact that the device can be rolled into a tube and slid onto the handle of a pan or that the device can be stored by placing it on a ferrous surface is not part of the claims or embodiments of this invention. What is shown and described are exemplary uses of the device not meant to be inclusive or exhaustive. Any design or use such that the device is placed on opposite sides of a surface of an object such that the magnets within the device sufficiently attract each other to hold the device in place and any other variations of design or use are within the ideas and principle of this invention.

What is claimed is:

1. A device for grasping a hot or cold object with the device remaining affixed to the object when the object is released, which device can be affixed or removed at will, the device consisting of: fabric or other material of sufficient insulating property into which is incorporated magnets in opposite corners or areas or edges of sufficient strength and opposite polarity to independently remain affixed to the object when the device is folded about a horizontal, vertical or diagonal axis and is placed on opposite surfaces of an edge of the object, or when two such devices are placed on opposite surfaces of an object.

2. The device in claim 1 in which permanent magnets are sewn into position between layers of the fabric and are wholly covered and incorporated into the device.

3. The device in claim 1 in which the permanent magnets are adhered to one or more layers of the fabric into position and are wholly covered and incorporated into the device.

4. The device in claim 1 in which the fabric or material is fashioned into an open or closed handle such that when the magnets of opposite polarity are placed on opposite sides of an object, the object can be lifted or moved by such handle.

5. A potholder comprising: one or more layers of any fabric or material and of any shape and size and of sufficient insulating property onto one layer or between the layers of which are affixed permanent magnets or electro-magnets in opposite corners or areas or along opposite edges with opposite polarities and having sufficient magnetic strength to hold the potholder on the edge of an object when the potholder is folded onto opposite surfaces of that edge.

6. The potholder in claim 5 in which the magnets can be of ferrous, ceramic, an alloy or any material and of any shape, permanent or electric, coated or uncoated, all of which can be magnetized to sufficient strength to function as described.

7. The potholder in claim 5 in which there are incorporated two or more magnets in such location that when the potholder is folded along one of either a horizontal, vertical or diagonal axis, ends of magnets or pairs of magnets of opposite polarity will attract each other and hold the potholder in that folded shape such that when the potholder is so folded about opposite sides of an object the potholder remains in the position about the object onto which it was placed.
